(19) United States
(12) Patent Application Publication
(10) Pub. No.: US 2014/0012697 A1
(43) Pub. Date: Jan. 9, 2014

(54) Intention Aggregation for Conditional Reverse Auction Scaled Purchasing

(71) Applicant: Scabu, Sao Paulo (BR)

(72) Inventors: Marcello Rachlyn, Sao Paulo (BR); Matheus R.F. Silva, Sao Paulo (BR)

(21) Appl. No.: 13/935,474

(22) Filed: Jul. 3, 2013

Related U.S. Application Data
(60) Provisional application No. 61/667,463, filed on Jul. 3, 2012.

(51) Int. Cl. G06Q 30/06

(52) U.S. Cl. CPC G06Q 30/0611
USPC 705/26.4

(57) ABSTRACT

A system and method for intention aggregation for conditional reverse auction purchasing to achieve economies of scale. Non-binding purchase intentions are aggregated from a number of potential buyers by a computer system to generate a purchase statement. The purchase statement is used to solicit participation in and conduct a reverse auction among a number of potential suppliers. A supply offer from the winning bid is then used to make purchase conversion offers to the potential buyers. The supply offer includes a minimum purchase requirement to provide the necessary economy of scale for the supplier. Potential buyers place conditional purchase orders that are conditioned on achieving the minimum purchase requirement to activate the supply offer. Once the supply offer is activated, the conditional purchase orders are converted into binding purchase orders and secure transactions to address payment and delivery can proceed.

### RELATIONSHIP TO PRIOR PATENT APPLICATION

This application claims the benefit of U.S. provisional Application No. 61/667,463, filed Jul. 3, 2012.

### TECHNICAL FIELD

This invention relates to the field of electronic commerce and, in particular, to scaled business purchasing by reverse auction.

### BACKGROUND

Small businesses have difficulty obtaining purchasing power or access to wholesale distributors. Small and Mid-sized businesses often spend more per unit because of low purchasing scale. Small and Mid-sized businesses can rarely organize themselves to buy together. Without a trusted third party there is no guarantee of transparency or integrity in collective action. Manually coordinating purchases among small businesses with similar needs, while possible, is cumbersome and raises concerns about assisting direct competitors.

Suppliers also have difficulty dealing with small businesses. One of the reasons for industry reliance on wholesalers, is producers' unwillingness to deal with small orders and the management of the payment and delivery issues they involve. Suppliers spend lots of money to sell to small and mid-sized businesses (transactions costs per unit are high). Low scale implies high sales force efforts and costs. Inability to address these added costs leads to lost sales and/or lower margins due to the need to use wholesalers as intermediaries.

It is often the case that there are a number of potential small business purchasers with similar needs. They have the intention to purchase a certain product in a desired quantity if they can find a supplier offering it at a certain price—usually below the price it is commonly offered through direct sale platform, such as Alibaba.com. Small volume purchases, even through a direct sale platform or online wholesaler, do not have the required buying power to encourage the kind of volume discounts that benefit larger corporate purchasers.

Online buying clubs and group deal services, such as Groupon, have developed models for aggregating consumer interests. However, these systems still rely on a high-level of buyer coordination, use pre-packaged supplier-driven offers, and/or, in the world of business-to-business transactions, often fail to reach critical mass (potentially leaving early adopters of the deal to lose the opportunity or forcing them to purchase more or at different terms than they intended). Due to limited resources, small businesses may be unwilling to tie themselves to a group purchase that is uncertain and requires that they be legally bound to purchase before the supplier and terms are certain.

One solution to the supplier-driven deal model is the use of reverse auctions. Online reverse auctions have been used in a number of contexts to assist purchasers of commodity products to get the best price. The use of reverse auctions to allow suppliers to compete for a business opportunity is known, but the logistics of such auctions can be difficult when the logistics of business-to-business supply transactions are considered. In addition, participation in reverse auctions is generally fully binding on both parties, which can be difficult for buyers who may be hesitant to deal with certain suppliers. For example, some business travelers dislike certain hotel chains or airlines. This makes it difficult for them to participate in reverse auctions for travel services due to the fear of being stuck with a bad carrier.

### SUMMARY

The present invention is an electronic commerce engine (including both a system and method) to enable the aggregation or grouping of the purchase intentions of multiple businesses in order to achieve attractive economies of scale. Individual purchase intentions are the amount of product desired, generally including a product or service specification and a window of interest. They are not legally binding to encourage expression of potential purchase interests. The aggregate non-binding purchase intentions of multiple businesses are then presented as a single, volume sales opportunity to multiple potential suppliers. The aggregate purchase intentions are generally posted in a purchase statement. This statement includes product or service detailed specifications, a window of time, an expected amount of product desired, and a minimum purchase requirement, the minimum percentage of the desired amount required to activate the sale. It is used to solicit interest in the sales opportunity. The suppliers then bid on the sales opportunity through a reverse auction. Once a low-price supplier is identified that can meet the common specifications, the supplier signs a trade contract or supply offer with the offer price, a statement of specifications and minimum and maximum amount to be supplied. The product is offered for purchase to the participating businesses that expressed their intention to purchase, generally with a commission and costs to cover their particular delivery and payment logistics built into the price. This is referred to as purchase conversion offer, since it converts the purchase intention into an actual, though conditional, purchase order. The transaction is not activated until the minimum participation level to meet the supplier's minimum purchase requirement is achieved through the conversion of enough purchase intentions into purchase orders. Once activated the conditional purchase orders become binding purchase orders. Secure transactions to address payment and delivery can then proceed through the system based on the supply offer and purchase orders.

In one aspect, once the minimum purchase requirement is achieved, and the exclusive conversion period (the period which buyers with purchase intentions have exclusivity to buy) is over and if there are still contracted amount not sold yet, then the offer is made available to other businesses for direct purchase on a more opportunistic basis (with a defined price, commission, seller, and specifications). Alternately, opportunistic buyers can be used to achieve the minimum participation level through a conditional offer mechanism prior to activation but after the expiration of the exclusivity period for responding to the purchase conversion offer. The aggregation of both the original purchase intentions and the ability to attract additional participants to the purchase are used to drive a volume purchase from the selected supplier.

In another aspect, the system includes an algorithm for determining favorable logistics costs for delivering purchased products to the participating businesses and displays projected grouped delivery costs to facilitate the identification of the best supplier bid. The system also includes a commission engine that calculates and charges a fee (a percentage of savings, previously agreed) for the service that is paid to the operator of the engine. The commission may be calculated into the purchase transaction presented to the buyers, sellers, or both and may be customized to individual participants to allow different commissions for intentional buyers, direct buyers, member/non-member buyers, etc.

In another aspect, the system is used to offer aggregate purchasing power through business associations, such as industry groups, industrial parks, chambers of commerce, etc., to their membership. It can be a hosted application integrated into the business association's website or offered as a branded application for access through smartphones, tablet computers, and other mobile devices. In this application, the commission module may enable commission sharing with the associated business association.

In another aspect, the e-commerce engine is embodied in a computer system. A joint purchase module for aggregating buyer purchase intentions from a plurality of potential buyers generates a purchase statement. The purchase statement defines an aggregate purchase opportunity for the plurality of potential buyers but does not legally bind them to purchase. A reverse auction module for conducting a reverse auction for a plurality of potential suppliers based on the purchase statement generates a supply offer from a winning supplier. The supply offer defines at least an offer price, an offer specification, and a minimum purchase requirement. It may also define a maximum amount available for sale. The joint purchase module receives the supply offer and communicates a purchase conversion offer to the plurality of potential buyers. The purchase conversion offer includes a period for response to the purchase conversion offer. The joint purchase module then receives conditional purchase orders from at least two of the plurality of potential buyers in response to the purchase conversion offer, aggregates the conditional purchase orders, compares them to the minimum purchase requirement, and activates the supply offer when the conditional purchase orders are equal to or greater than the minimum purchase requirement. The active supply offer converts the conditional purchase orders into binding purchase orders.

In another aspect, the joint purchase module further comprises a scheduling module that defines a plurality of offer response periods for achieving the minimum purchase requirement. It includes the period for response to the purchase conversion offer. During that period, the purchase conversion offer is available exclusively to the potential buyers that communicated purchase intentions for that purchase statement. If more buyers are needed or more supply is available, there is a second period for a direct purchase offer. The direct purchase offer is for potential buyers other than the original potential buyers with purchase intentions.

In another aspect, the joint purchase module further comprises an accommodation module which is triggered when the minimum purchase requirement is not met by a final deadline for response to the supply offer. The accommodation module communicates with the plurality of potential buyers and/or the winning supplier to negotiate an alternate supply offer that could be activated.

In another aspect, the joint purchase module further comprises a commission module that calculates a commission for each of the plurality of potential buyers that is included in the purchase conversion offer. If the opportunity includes both a purchase conversion offer and a direct purchase offer, the commission module calculates a different commission for the direct purchase offer and the purchase conversion offer. The commission may be based on the difference between a published wholesale or catalog price versus the price in the supply offer, such as a percentage of savings.

In another aspect, the joint purchase module includes a purchase intention module that hosts a plurality of member profiles. The member profiles are analyzed to identify members with characteristics indicative of potential buyer interests among a plurality of members. The purchase intention module may use historical data from prior active supply offers and the member profiles to identify opportunities for intention aggregation and generate a request for purchase intentions to members who could be potential buyers.

In another aspect, the joint purchase module includes an aggregator module that iteratively selects and varies specifications for an aggregate purchase opportunity. It communicates the selected specifications to the plurality of potential buyers to reach a common set of specifications that generates the most interest. The common set of specifications and the purchase intentions received during the aggregation process can then be used to generate the purchase statement.

In another aspect, the joint purchase module receives logistical requirements from the plurality of potential buyers and calculates the logistical costs into the purchase conversion offer. The reverse auction module receives the logistical requirements and calculates a logistical relative factor used in determining the winning bid of the reverse auction.

In another aspect, the reverse auction module includes supplier data derived from a plurality of sources, such as industry directories, website registrations, and referral sources, and the reverse auction module selectively communicates the purchase statement to the plurality of potential suppliers based on supplier data indicative of potential interest in bidding on the purchase statement.

In another aspect, the plurality of potential buyers is selected from the membership of a sponsoring business association and the sponsoring business association receives a portion of a commission from the binding purchase orders.

In another aspect, a secure transaction module is in communication with the joint purchase module and the reverse auction module. It receives the binding purchase orders and generates supply orders after buyer verification. It handles payment and delivery terms incorporating the logistical requirements of the binding purchase orders.

In another aspect, the e-commerce engine is a method of using a computer system to generate a plurality of binding purchase orders from aggregate purchase intentions of a plurality of potential buyers. The computer executes the following steps: 1) collecting purchase intentions from the plurality of potential buyers, wherein the purchase intentions are non-binding offers to purchase; 2) aggregating the purchase intentions to generate a purchase statement representing the collected purchase intentions of the plurality of potential buyers; 3) publishing the purchase statement to a plurality of potential suppliers to solicit participation in a reverse auction using the computer system; 4) conducting a reverse auction to receive at least one conforming bid with at least an offer price, an offer specification, and a minimum purchase requirement; 5) selecting a supplier based on a winning bid; 6) generating a supply offer from the selected supplier based on the winning bid; 7) providing a purchase conversion offer based on the winning bid to the plurality of potential buyers with a fixed period for response to the purchase conversion offer; 8) receiving conditional purchase orders from at least one of the plurality of potential buyers during the fixed period for response to the purchase conversion offer; 9) activating the supply offer based on the conditional purchase orders being equal to or greater than the minimum purchase requirement; and 10) converting the conditional purchase orders into binding purchase orders. The method may also include the steps of providing a direct purchase offer based on the winning bid to potential buyers other than the plurality of potential buyers from which the purchase intentions were collected with a fixed period for response to the direct purchase offer; and receiving conditional purchase orders from at least one of the potential buyers other than the plurality of potential buyers from which the purchase intentions were collected during the fixed period for response to the direct purchase offer. The method may also include the step of calculating different commission and logistics charges for each purchase conversion offer and direct purchase offer. The method may also include the step of iteratively modifying terms of an opportunity to collect purchase intentions to increase the plurality of potential buyers participating in the purchase statement. The method may also include the step of calculating a logistical relative factor for use in the step of selecting a supplier based on a winning bid. Where the winning bid includes a maximum purchase available, the method may include the step of providing alternative offers for binding purchase orders after the supply offer has been activated.

In another aspect, the e-commerce engine is a software application hosted on a computer system for access over the internet.

### BRIEF DESCRIPTION OF THE DRAWINGS

FIG. 1 is a block diagram of a computer system in accordance with one embodiment of the present invention.

FIG. 2 is a block diagram of the joint purchase module of the computer system of FIG. 1.

FIG. 3 is a block diagram of the reverse auction module of the computer system of FIG. 1.

FIG. 4 is a block diagram of the secure transaction module of the computer system of FIG. 1.

FIG. 5 is a flow chart of a process for generating a supply offer from aggregate purchase intentions using a reverse auction in accordance with one embodiment of the present invention.

FIG. 6 is a flow chart of a process for generating binding purchase orders from a supply offer, such as the supply offer in FIG. 5.

FIG. 7 is a flow chart of a method of operating an e-commerce engine in accordance with one embodiment of the present invention.

### DETAILED DESCRIPTION

The purpose of the e-commerce engine is to enable purchases by small and medium sized businesses with attractive economies of scale for both buyer and seller. It is most effective for standardized products/services, organized sectors (by trade associations, local productive arrangements, industrial parks, etc.), fragmented buyers and/or suppliers, and easy to deliver (ex: services). For example, the system lends itself to: tires, insurance, fire extinguishers, and some common chemical products. Niche products and services can be attractive opportunities when aggregating within an industry with common needs. For example, chemicals for small pest control companies could be offered through a trade association that knows the most commonly used products.

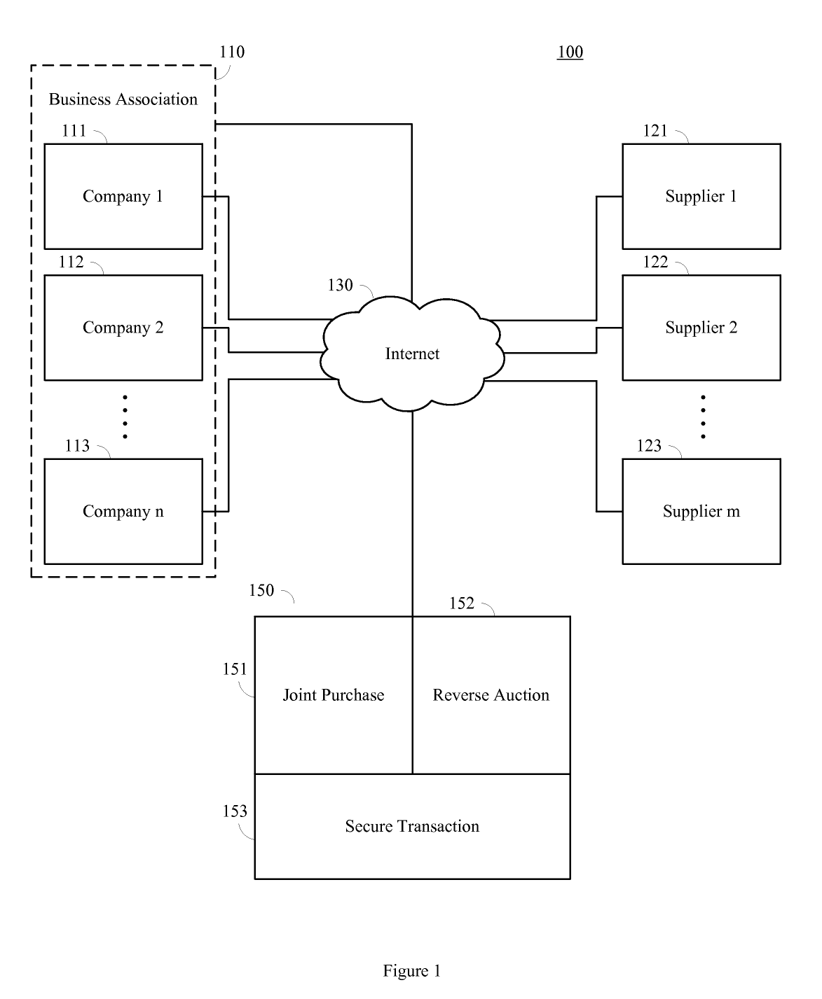

FIG. 1 shows a computer system 100 connecting multiple buyer companies 111, 112, 113 with multiple suppliers 121, 122, 123 via the Internet 130. The number n, m of potential buyer companies and supplier companies is limited only by the data, processing, and connective capabilities of the computer system 100 and the target market. As shown, the companies 111, 112, 113 may optionally be organized into a business association.

The computer system 100 includes an e-commerce engine 150 that is comprised of three functional modules, joint purchase module 151, reverse auction module 152, and secure transaction module 153. The e-commerce engine 150 may be a hosted software application on one or more servers remote from the companies 111, 112, 113 or suppliers 121, 122, 123. Joint purchase module 151 includes the data and processing instructions for managing the interactions with potential buyers, such as companies 111, 112, 113, for the purpose of aggregating purchase intentions and making and accepting purchase offers. Reverse auction module 152 includes the data and processing instructions for managing the interactions with potential suppliers, such as suppliers 121, 122, 123, for the purpose of conducting reverse auctions. Secure transaction module 153 includes the data and processing instructions for managing the interactions with actual buyers and suppliers selected from the potential buyer companies and suppliers through the joint purchase module 151 and reverse auction module 152. The secure transaction module 153 may also communicate with third party financing and logistics or delivery services (not shown) to facilitate completion of secure purchase transactions.

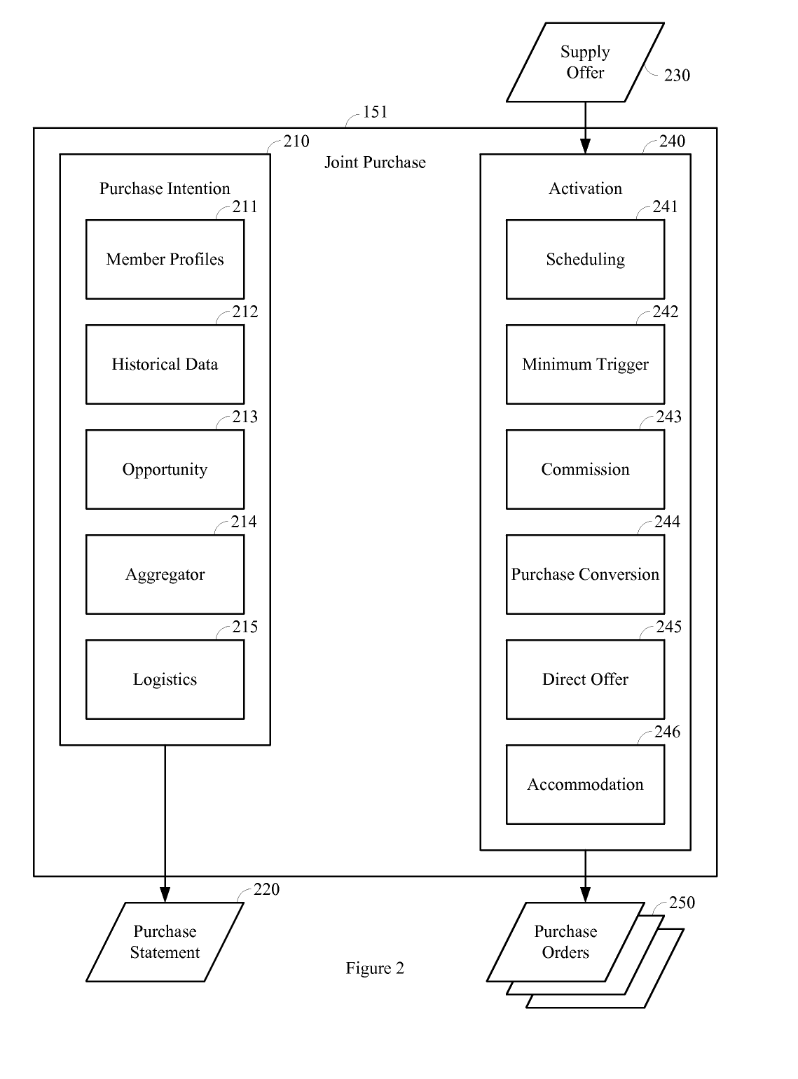

FIG. 2 shows the joint purchase module 151 from FIG. 1 in more detail. The joint purchase module 151 includes a purchase intention module 210 and an activation module 240.

The purchase intention module 210 interacts with potential buyers to generate a purchase statement 220. The purchase statement 220 includes product or service detailed specifications, a window of time, an expected amount of product desired, and a minimum purchase requirement, the minimum percentage of the desired amount required to activate the sale. It is used to solicit interest in the sales opportunity from suppliers. The purpose of the purchase intention module is to aggregate non-binding purchase intentions in order to build an attractive business case for volume suppliers to bid on.

The purchase intention module 210 includes member profiles module 211, historical data module 212, opportunity module 213, aggregator module 214, and logistics module 215.

To facilitate efficient aggregation of purchase intentions, the purchase intention module 210 may include a member profiles module 211 for profiling buyer participants. The profile may start with basic business and geographic information and then be supplemented by the member's purchase history, additional information requests, and/or insights on purchasing behavior from market data aggregators and analysts. The buyers may subscribe themselves (directly or invited by a trade association) and register their purchase needs and interests through the member profiles module 211. Based on the participant profiles, one business' purchase intention can be used to automatically create a solicitation to similar businesses likely to have an interest in similar products, with the goal of identifying additional purchase intentions for aggregation. The member profiles module 211 may also be able to use the buyer participant data to predict likely products of interest and encourage the formation of purchase intentions.

The member profiles module 211 may work in conjunction with the historical data module 212 to assist in the analysis of member information, industry trends, aggregate information from adjacent industries or similar business organizations. Where the member profiles module 211 exists to identify individual interests and trends, historical data module 212 uses broader aggregate data, including data regarding prior active supply offers and deal failures to assist in facilitating successful aggregation of purchase intentions.

The opportunity module 213 enables the purchase intention module 210 to identify purchase opportunities independent of a specific member identifying a purchase intention. The opportunity module 213 mines the member profiles module 211 and historical data module 212 to create and present opportunities that are justified by demographic market analysis of the member profiles or success of a prior supply offer.

Once an opportunity is identified by either communication of an original purchase intention from a potential buyer or a system generated opportunity from the opportunity module 213, the aggregator module 214 acts to increase participation by refining and marketing a common offer. The objective is to increase the number of compatible purchase intentions that can be aggregated into a purchase statement 220. Individual small business participants may have slightly different intentions in terms of product specifications, timing, logistics, and other drivers of individual firm value. The aggregator module 214 would use various means to test variations in purchase intentions to reach participant group consensus and create the best aggregate sale offer to attract competitive bids in the reverse auction. For example, the aggregator module 213 could start from a first user's initial intentions and compare them against existing product catalogs and successful prior transactions to suggest specifications and/or identify critical features in the initial intentions. As the potential purchase terms are offered to other users to encourage them to declare their purchase intentions, the aggregator module 214 can modify terms that were not identified as critical by other participants to maximize participation.

The logistics module 215 captures and tracks the logistics requirements for each purchase intention. These can be provided by the potential buyer as part of their purchase intention or can be retrieved from the member profiles module 211. The logistics module 215 can cross-reference location and transportation requirements with available carrier services to calculate a transport cost for each purchase intention of a potential buyer. This information can then be used by the reverse auction module 152 to calculate the logistical relative factor and assist in correctly awarding the winning bid that maximizes the value to the most potential buyers with purchase intentions.

The activation module 240 receives a supply offer 230 and interacts with potential buyers to generate binding purchase orders 250. One of the challenges of the transaction is the conversion of purchase intentions into actual contracts to purchase. This is managed within the activation module 240 once an aggregate supply offer 230 from a willing supplier has been identified. In order to encourage participation in forming purchase intentions, the potential buyer is not contractually obligated to purchase the product even if a supplier is identified. But sellers will require a minimum purchase that must be achieved to activate their deal (since the point of the aggregation is to achieve volume discounts from the suppliers). The supply offer 230 comes from the reverse auction module 152 and constitutes a trade contract executed by the winning supplier with the offer price, a statement of specifications, and minimum and maximum amount to be supplied. A binding purchase order 250 would include all information and formalities for an enforceable commercial contract under the Uniform Commercial Code, United Nations Convention on Contracts for the International Sale of Goods, or other applicable law. The binding purchase order 250 would clearly identify the parties, the goods or services being purchased, purchase price (including commissions and logistics costs), amount purchased, and such delivery, financial, and other terms as are reasonably necessary for the completion of the transaction. The activation module 240 includes scheduling module 241, minimum trigger module 242, commission module 243, purchase conversion module 244, direct offer module 245, and accommodation module 246.

Once aggregate purchase intentions are formed and a supplier identified, there are strict rules to govern the process of moving from intentions to actual purchase, in order to protect all participants in the system. The scheduling module 241 establishes strict time lines during which each type of offer can be made or accepted and the deadlines for reaching activation or accepting deal failure. For example, the potential buyers who placed purchase intentions would have 5 days from the date of distribution of the purchase conversion offer to accept it and, in some cases, maintain the exclusive option to take advantage of the supply offer 230. This is sometimes referred to as the first gate in the activation process. Other potential buyers would have 10 days from the end of the exclusive purchase conversion period to place conditional purchase orders and attempt to meet the sale activation conditions (minimum purchase requirement). This sale activation deadline would be 15 days from the date of distribution of the original purchase conversion offers. This is sometimes referred to as the second gate in the activation process. If the activation conditions are met, the supplier's obligation to leave the offer open would extend 30 days from distribution of the initial offer or until the maximum available purchase is met.

The minimum trigger module 242 establishes and tracks the conditions for activating the supply offer and converting conditional purchase orders into binding purchase orders 250. The minimum trigger module 242 is generally set for a minimum number of conversions of purchase intentions to purchase order equaling or exceeding the minimum purchase requirement defined by the supplier in the supply offer 230. Activation is necessary for the supplier to be obliged to deliver the product at the agreed price and for the conditional purchase orders to become binding and legally enforceable purchase orders for the potential buyers. The activation module 240 is charged with converting purchase intentions into actual purchases in order to trigger the seller's obligation to supply the product. This important transaction point is called minimum trigger activation (MTA). An example of MTA is that is not a supplier defined minimum purchase requirement would be based on converting a specific percentage of purchase intentions. For example, if we have 50% of the purchase intentions in 5 days, the sellers will be obligated to sell. The buyers that posted the purchase intentions will have exclusivity to convert those intentions in buying orders during that time by contract. At the end of the fifth day, if the MTA is not achieved, other companies will be able to buy the product until the first deadline (15 days). If the MTA is not achieved in the first deadline (15 days), the process fails and all participants are warned. Is the MTA is achieved, the engine delivers all the purchasing orders accumulated until this time. If the engine achieves the MTA, the remaining products for sale could be sold to any interested buyer until the end of the second deadline (30 days).

The commission module 243 calculates and charges a fee, generally a percentage of savings previously agreed or built into the terms of use of the system, for the service that is paid to the operator of the e-commerce engine 150. The commission may be calculated into the purchase transaction presented to the buyers, sellers, or both and may be customized to individual participants to allow different commissions for intentional buyers, direct buyers, member/non-member buyers, etc. The commission module 243 may calculate a commission for each of the plurality of potential buyers that is included in the purchase conversion offer. If the opportunity includes both a purchase conversion offer and a direct purchase offer, the commission module may calculate a different commission for the direct purchase offer and the purchase conversion offer. In one example, the commission is charged solely to the purchasers and is based on the difference between a published wholesale or catalog price versus the price in the supply offer. The percentage of the savings charged is lower for conversion offer buyers versus direct offer buyers to reward those who proactively identified their intention to purchase. The commission module 243 includes the commission in the offers so that potential buyers are aware of the total cost of their purchase commitment.

The purchase conversion module 244 oversees the process of potential buyers with purchase intentions converting their intentions into a conditional purchase order. At the conversion stage, there are three options: 1) conversion based on intentions to order until the first gate; 2) recall based on intentions to order between the first and second gate; and 3) minimum level not reached. For option 1, ideally, minimum purchase level is reached before the first gate is reached, generally five or seven days after auction, with the conversion of the preferential buyers (with posted purchase intention). In this case, we offer a second chance for buyers that didn't post purchase intentions through the direct offer module 245 if the maximum available has not been reached, possibly with a differentiated commission. For option 2, if the minimum was not reached at the first gate, the engine recalls the potential buyers without posted purchase intentions to complete the deal. This may be at the same commission rate as those with posted purchase intentions to encourage reaching the necessary aggregate commitment to complete the deal. This may be done in parallel with direct offers through direct offer module 245 to improve the likelihood of activation. For option 3, if the minimum is not reached after a multiple attempts to reach all interested buyers, the deal will likely fail.

However, the activation module 240 also includes logic for attempting to complete the deal in accommodation module 246, such as by offering the lower purchase amount to the seller or asking those with purchase commitments if they are willing to increase their purchase amount to meet the minimum transaction requirements. The accommodation module 246 is triggered when the minimum purchase requirement is not met by a final deadline for response to the supply offer. The accommodation module communicates with the plurality of potential buyers and/or the winning supplier to negotiate an alternate supply offer that could be activated.

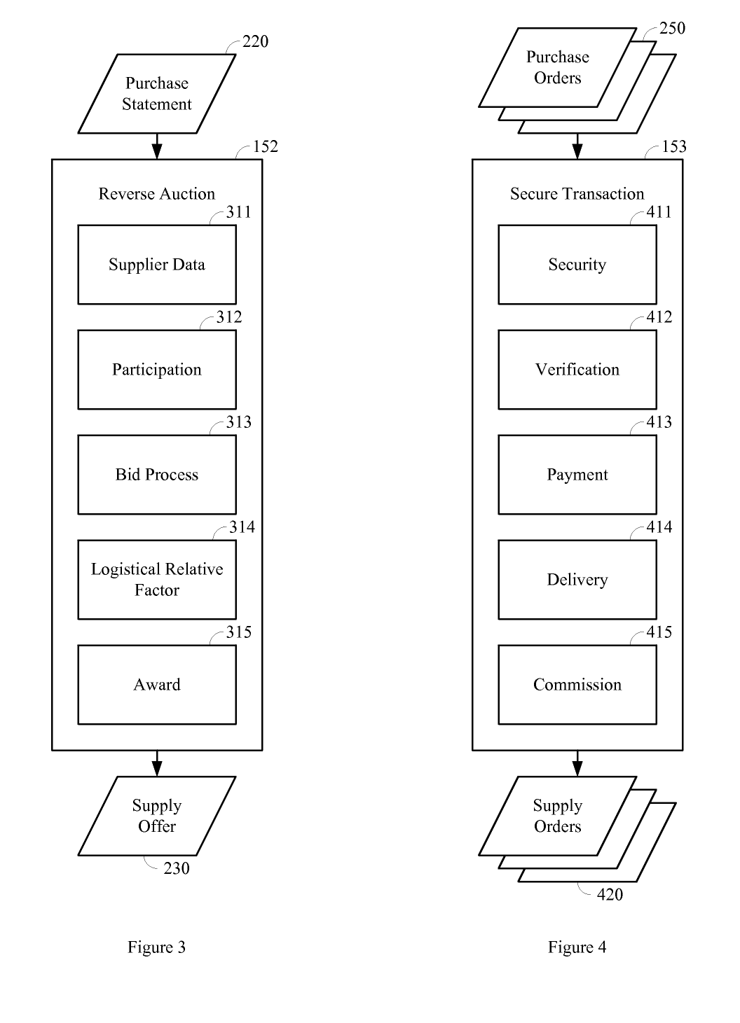

FIG. 3 shows the reverse auction module 152 from the computer system 100 in FIG. 1 in more detail. The reverse auction module 152 receives the purchase statement 220 and generates the supply offer 230. The reverse auction module 152 includes supplier data module 311, participation module 312, bid process module 313, logistical relative factor module 314, and award module 315.

The supplier data module 311 allows potential suppliers to self-identify and register. It may also include a mechanism for mining potential suppliers from other sources, such as online catalogs, supplier websites, industry directories, purchased lists, referral services, or research.

The participation module 312 uses the information in the supplier data module 311 to match potential suppliers with the sales opportunity in the purchase statement 220. The participation module 312 may reformat the purchase statement 220 into an industry accepted format for soliciting participation in the bidding process of the reverse auction. For example, the potential suppliers for a determined group of products/services may receive the aggregate sales opportunity presented as a request for proposals/quotations (RFP/RFQ) or similar competitive sales opportunity understood by the relevant industry. Suppliers interested in selling higher amounts are thereby encouraged to register to participate in the reverse auction.

The bid process module 313 manages the reverse auction bid process with the suppliers registered for the auction. The bid process module 313 includes clear terms of use that set forth a transparent and timely process for receiving and evaluating supplier bids. It generates an Auction Statement for a specific product with specifications defined by the purchase statement and a recommended minimum purchase requirement based on the aggregate purchase intentions. It also disclosed the conditional nature of the auction and the process by which the winning bid will be activated. The participating suppliers can then bid their best net cash price per unit to win the entire opportunity. The bid process module 313 can operate based on closed or open bidding and, in the case of open bidding, will validate conforming bids prior to posting them.

The logistical relative factor module 314 calculates a Logistical Relative Factor. Every participating supplier will have its logistic cost calculated by the logistical relative factor module taking in consideration the geographic location of their distribution centers, the geographic location of the potential registered buyers and also the buyers' number of purchase intentions. For example, each supplier will have a transport factor depending on an average cost to deliver. If alternate carriers are also available, that may be considered in calculating the transport factor. Transport factor will be calculated using the distance between each supplier and buyers weighted by purchase intentions of each buyer. It may also take into consideration other considerations for individual suppliers or potential buyers, such as the availability of loading docks, restricted delivery hours, and similar considerations. An example calculation of the Logistical Relative Factor for a single suppler bid would be: Transport Factor Supplier 1=(Transport cost Buyer1*Intentions Buyer1)+(Transport cost Buyer2*Intentions Buyer2)+ . . . +(Transport cost BuyerN*Intentions BuyerN). This factor can be taken into consideration in the reverse auction in order to ensure the best aggregate result for the purchasers. Once the supplier is identified, the logistics and delivery costs can be represented in the actual offers for the conversion of purchase intentions to purchase commitments.

The award module 315 homologates the winning supplier based upon the actual bids and the Logistical Relative Factor. The award module 315 notifies the winning supplier, generates the trade contract for execution by the winning supplier, and creates the supply offer 230 for the joint purchase module 151 to attempt to activate.

FIG. 4 shows the secure transaction module 153 from FIG. 1 in greater detail. The secure transaction module 153 receives purchase orders 250 from the joint purchase module 151. Based on the purchase orders 250 and the trade contract executed by the winning supplier, as well as the general terms and conditions of the system, the secure transaction module 153 acts as an intermediary in assisting buyers and suppliers to complete the transaction, deliver the product to the buyer, pay the seller, and pay the commission due the owner of the e-commerce engine 150. It receives the binding purchase orders and generates supply orders after buyer verification. It handles payment and delivery terms incorporating the logistical requirements of the binding purchase orders. The secure transaction module 153 includes a security module 411, a verification module 412, a payment module 413, a delivery module 414, and a commission module 415. The security module 414 provides for the confidentiality, transaction authentication, and protection of financial information passed through the system. The verification module 412 verifies buyer identity, payment, and/or credit worthiness to assure smooth completion of the transaction process and ensure that a single bad buyer does not disrupt the transaction of the supplier or other buyers. The payment module 413 provides for the transfer of funds from buyer to seller. The system may act as intermediary, use a third party service for handling the transfer, or facilitate direct transfer between the parties. The delivery module 414 establishes and tracks the delivery of the product (or service) from seller to each buyer. The system may act as intermediary, user a third party service for handling delivery logistics and tracking, or directly manage delivery. The commission module 415 collects commissions, generally from the buyer, but other business models are possible, including commission payments by the seller or business association. More commonly, the business association my receive a portion of the collected commission for access to their members and encouraging participation. Supply orders 420 are the electronic or other documentation necessary to initiate the delivery of the product from the supplier to the buyer.

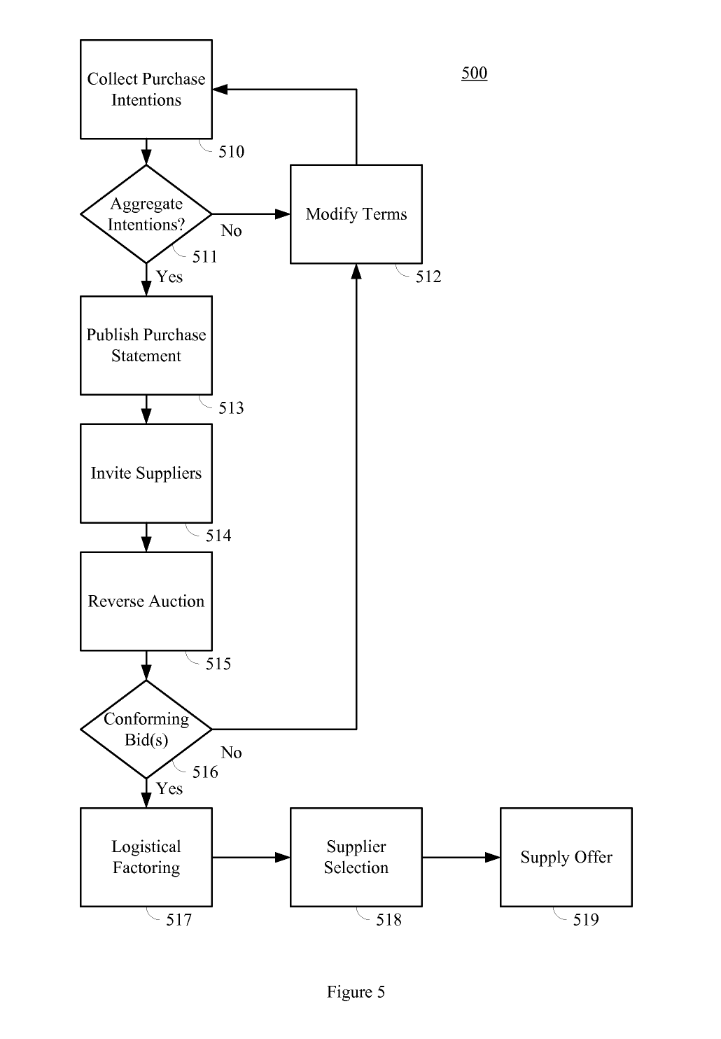

FIG. 5 is a flow chart of a process 500 for generating a supply offer from aggregate purchase intentions using a reverse auction. In process 510, a computer system collects purchase intentions from multiple users. For example, as described for purchase intention module 210 in FIG. 2 using member profile module 211, historical data module 212, and opportunity module 213. In decision 511, the computer system evaluates whether sufficient purchase intentions have been aggregated for an opportunity worth presenting to suppliers. If the answer is no, the computer system proceeds to process 512 to modify terms, contact additional potential buyers, and otherwise aggregate intentions until an opportunity threshold is reached. For example, as described for aggregator module 214. If the answer to decision 511 is yes, the computer system proceeds to process 513 and publishes a purchase statement. For example, as described for purchase statement 220. The computer system continues to process 514 and invites suppliers. For example, as described for reverse auction module 152 in FIG. 3 using supplier data module 311 and participation module 312. In process 515, the computer system conducts a reverse auction. For example, as described for bid process module 313. At decision 516, the computer system evaluates whether there are sufficient conforming bids for a valid auction. If no, the computer returns to process 512 and continues to iterate toward an opportunity more appealing to potential suppliers. If yes, logistical factoring is applied in process 517. For example, as described for logistical relative factor module 314. In process 518, a supplier is selected. For example, as described for award module 315. In process 519, a supply offer is generated. For example, as described for supply offer 230.

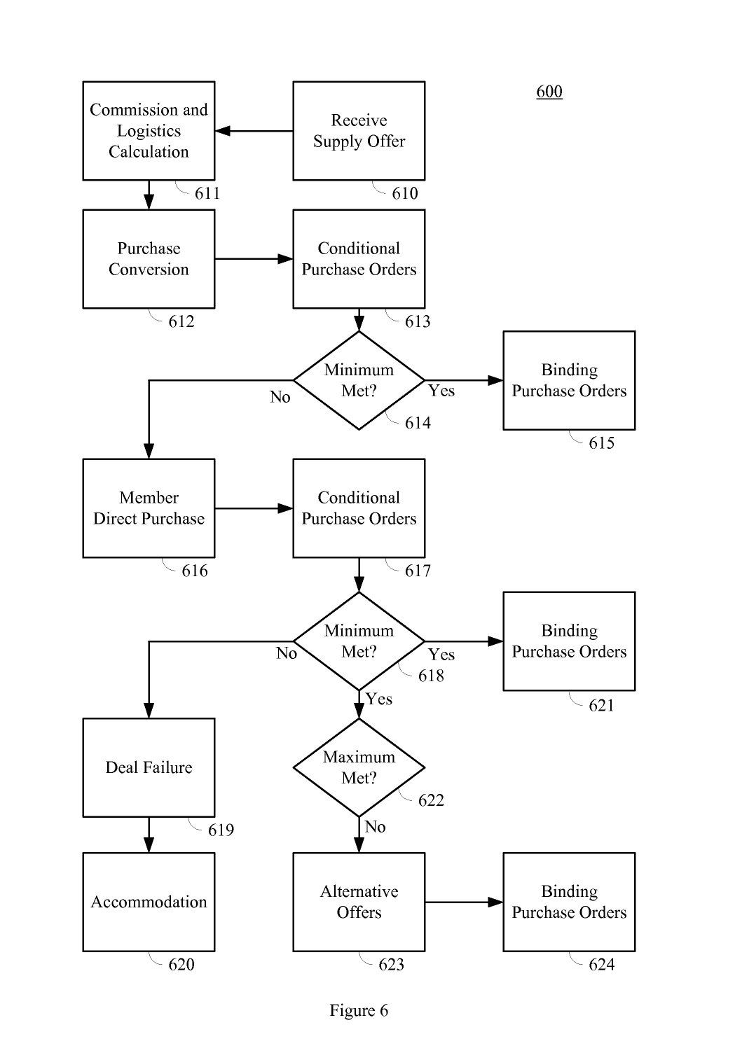

FIG. 6 is a flow chart of a process 600 for generating binding purchase orders from a supply offer, such as the supply offer generated in FIG. 5. In process 610, a supply offer is received. For example, as described for supply offer 230 and activation module 240 in scheduling module 241 and minimum trigger 242. In process 611, commission and logistics calculations are made for each potential buyer and in process 612 purchase conversion offers are made to the potential buyers with purchase intentions. For example, as described in commission module 243 and purchase conversion module 244. In process 613, a number of conditional purchase orders are created based on the potential buyers who accept the purchase conversion offer. In decision 614, the computer system evaluates whether the minimum threshold for activation and/or minimum purchase requirements have been met. If yes, activation of the supply offer occurs and binding purchase orders are created from the conditional purchase orders in process 615. For example, as described for purchase orders 250. If no, an additional purchase option is created for direct purchases in process 616. For example, as described for direct offer module 245. Direct purchase offers that are accepted by the potential purchasers generate conditional purchase orders in process 617. In decision 618, the computer system again evaluates whether the minimum threshold for activation and/or minimum purchase requirements have been met. If no, the deal fails in process 619 and proceeds to the accommodation process 620. For example, as described for accommodation module 246. If yes, activation creates binding purchase orders in process 621. In addition, the computer system evaluates whether the maximum available for sale has been met in decision 622. If yes (not shown), there is no further action other than processing of the binding purchase orders. If no, alternative offers may be created in process 623 in an attempt to generate additional binding purchase orders in process 624 for the remaining available product.

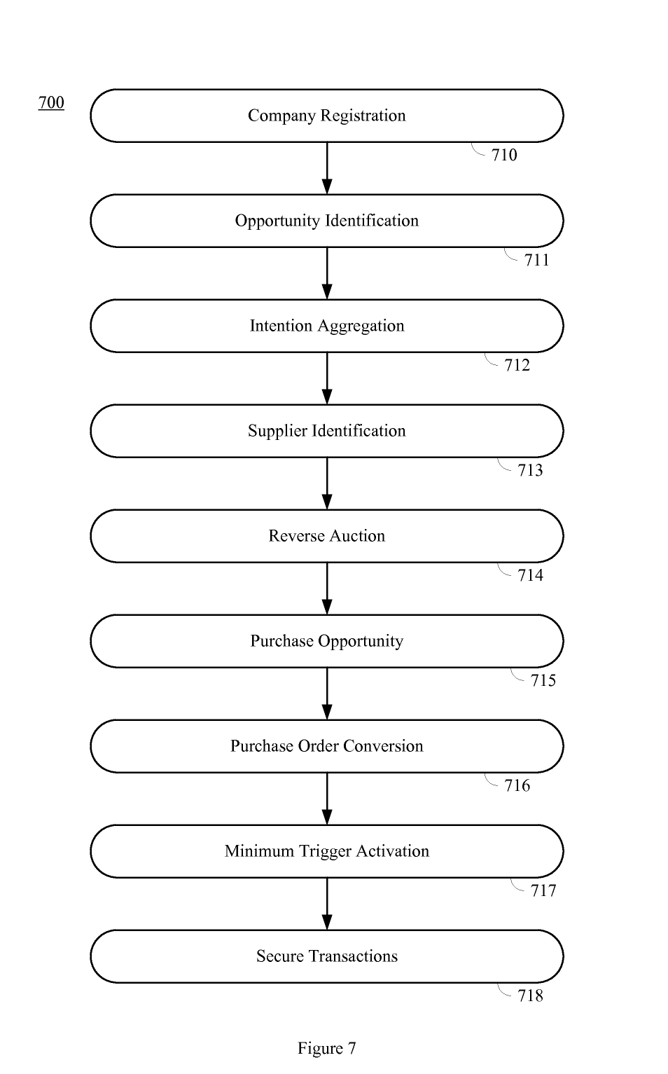

FIG. 7 is a flow chart of a method 700 of operating an e-commerce engine for intention aggregation and a conditional reverse auction for scaled business purchasing. The method 700 provides a user perspective on the operation of the systems and processes. In step 710, a company registers with the e-commerce engine. In step 711, the user or the e-commerce engine identify an opportunity that would lend itself to intention aggregation. In step 712, the e-commerce engine proactively attempts to aggregate purchase intentions to create an appealing supply opportunity. In step 713, the e-commerce engine identifies suppliers with the potential to respond to the supply opportunity that the aggregate purchase intentions represent. In step 714, the e-commerce engine conducts a reverse auction with the identified suppliers interested in bidding on the supply opportunity. In step 715, based on the outcome of the reverse auction, a purchase opportunity is defined and offers are made to potential buyers, including those who expressed purchase intentions. In step 716, potential buyers receiving the offers accept them and convert their purchase intentions or a direct offer into a conditional purchase order. In step 717, a minimum trigger or threshold for activation is achieved and the conditional purchase orders are converted to binding purchase orders. In step 718, secure transactions are completed between the supplier and the buyers with binding purchase orders, with a commission paid to the owner of the e-commerce engine.

Example transactions using the described systems and methods might look like:

| | | No. | Auction | Market | Winning | Unit | % | Total |
|---|---|---|---|---|---|---|---|---|
| Item | Quantity | Vendors | time | price | bid | economy | economy | economy |
| Signaling | 50 | 3 | 2 h | R$ | R$ 1.400 | R$ 3.500 | 71.43% | R$ |
| LED bar | | | | 4.900 | | | | 175.000 |
| for trucks | | | | | | | | |
| Reel truck | 50 | 4 | 1 h 20′ | R$ | R$ 2.640 | R$ 340 | 11.41% | R$ |
| 4 ton | | | | 2.980 | | | | 17.000 |
| Adjustable | 80 | 5 | 1 h 02′ | R$ | R$ 860 | R$ 540 | 38.57% | R$ |
| nozzle gun | | | | 1.400 | | | | 43.200 |
| 4 ton | 40 | 4 | 1 h 45′ | R$ | R$ 1.800 | R$ 1.100 | 37.93% | R$ |
| electric | | | | 2.900 | | | | 44.000 |
| winch | | | | | | | | |
| Electricity | 40 | 6 | 3 h 46′ | R$ | R$ 1.050 | R$ 1.250 | 54.35% | R$ |
| generator | | | | 2.300 | | | | 50.000 |
| gasoline | | | | | | | | |
| unit 6.5 | | | | | | | | |
| HP | | | | | | | | |

The full engine may not be used for all transactions. For example, it may be possible for a single buyer to conduct a reverse action with a supplier-base without aggregating purchase intentions with other buyers. Or, suppliers may be able to offer products or services directly to the customer base without auction. Such direct offers could still be validated by submitting an equivalent RFP/RFQ to other registered suppliers to validate the price being offered. Such offers may or may not include a minimum amount for activation.

1. A computer system comprising:
a joint purchase module for aggregating buyer purchase intentions from a plurality of potential buyers to generate a purchase statement defining an aggregate purchase opportunity for the plurality of potential buyers; and
a reverse auction module for conducting a reverse auction for a plurality of potential suppliers based on the purchase statement and generating a supply offer from a winning supplier that defines at least an offer price, an offer specification, and a minimum purchase requirement; and
wherein, the purchase statement does not legally bind the plurality of potential buyers to purchase;
the joint purchase module receives the supply offer and communicates a purchase conversion offer to the plurality of potential buyers with a period for response to the purchase conversion offer;
the joint purchase module receives conditional purchase orders from at least two of the plurality of potential buyers in response to the purchase conversion offer, aggregates the conditional purchase orders, compares them to the minimum purchase requirement, and activates the supply offer when the conditional purchase orders are equal to or greater than the minimum purchase requirement; and
the active supply offer converts the conditional purchase orders into binding purchase orders.

2. The computer system of claim 1, wherein the joint purchase module further comprises a scheduling module that defines a plurality of offer response periods for achieving the minimum purchase requirement, including:
the period for response to the purchase conversion offer, wherein the purchase conversion offer is available exclusively to the plurality of potential buyers that communicated purchase intentions used to generate the purchase statement; and
a second period for a direct purchase offer to potential buyers other than the plurality of potential buyers that communicated purchase intentions used to generate the purchase statement.

3. The computer system of claim 1, wherein the joint purchase module further comprises an accommodation module which is triggered when the minimum purchase requirement is not met by a final deadline for response to the supply offer and wherein the accommodation module communicates with the plurality of potential buyers and the winning supplier to negotiate an alternate supply offer that could be activated.

4. The computer system of claim 1, wherein the joint purchase module further comprises a commission module that calculates a commission for each of the plurality of potential buyers that is included in the purchase conversion offer.

5. The computer system of claim 4, wherein the joint purchase module includes the purchase conversion offer and a direct purchase offer and the commission module calculates a different commission for the direct purchase offer and the purchase conversion offer.

6. The computer system of claim 1, wherein the joint purchase module includes a purchase intention module that hosts a plurality of member profiles and wherein the plurality of member profiles are analyzed to identify members with characteristics indicative of potential buyer interests among a plurality of members.

7. The computer system of claim 6, wherein the purchase intention module uses historical data from prior active supply offers and the plurality of member profiles to identify opportunities for intention aggregation and generate a request for purchase intentions to the plurality of potential buyers.

8. The computer system of claim 1, wherein the joint purchase module includes an aggregator module that iteratively selects and varies specifications for an aggregate purchase opportunity and communicates the selected specifications to the plurality of potential buyers to reach a common set of specifications to receive purchase intentions from the plurality of potential buyers and generate the purchase statement.

9. The computer system of claim 1, wherein the joint purchase module receives logistical requirements from the plurality of potential buyers and calculates the logistical costs into the purchase conversion offer.

10. The computer system of claim 9, wherein the reverse auction module receives the logistical requirements from the plurality of potential buyers and calculates a logistical relative factor used in determining the winning bid of the reverse auction.

11. The computer system of claim 1, wherein the reverse auction module includes supplier data derived from a plurality of sources and the reverse auction module selectively communicates the purchase statement to the plurality of potential suppliers based on supplier data indicative of potential interest in bidding on the purchase statement.

12. The computer system of claim 1, wherein the plurality of potential buyers is selected from the membership of a sponsoring business association and the sponsoring business association receives a portion of a commission from the binding purchase orders.

13. The computer system of claim 1, further comprising a secure transaction module that receives the binding purchase orders and generates supply orders based on buyer verification and including payment and delivery terms incorporating the logistical requirements of the binding purchase orders.

14. A method of using a computer system to generate a plurality of binding purchase orders from aggregate purchase intentions of a plurality of potential buyers, wherein the computer executes steps comprising:
collecting purchase intentions from the plurality of potential buyers, wherein the purchase intentions are non-binding offers to purchase;
aggregating the purchase intentions to generate a purchase statement representing the collected purchase intentions of the plurality of potential buyers;
publishing the purchase statement to a plurality of potential suppliers to solicit participation in a reverse auction using the computer system;
conducting a reverse auction to receive at least one conforming bid with at least an offer price, an offer specification, and a minimum purchase requirement;
selecting a supplier based on a winning bid;
generating a supply offer from the selected supplier based on the winning bid;
providing a purchase conversion offer based on the winning bid to the plurality of potential buyers with a fixed period for response to the purchase conversion offer;
receiving conditional purchase orders from at least one of the plurality of potential buyers during the fixed period for response to the purchase conversion offer;
activating the supply offer based on the conditional purchase orders being equal to or greater than the minimum purchase requirement; and
converting the conditional purchase orders into binding purchase orders.

15. The method of claim 14, further comprising the steps of:
providing a direct purchase offer based on the winning bid to potential buyers other than the plurality of potential buyers from which the purchase intentions were collected with a fixed period for response to the direct purchase offer; and
receiving conditional purchase orders from at least one of the potential buyers other than the plurality of potential buyers from which the purchase intentions were collected during the fixed period for response to the direct purchase offer.

16. The method of claim 15, further comprising the step of calculating different commission and logistics charges for each purchase conversion offer and direct purchase offer.

17. The method of claim 14, further comprising the step of iteratively modifying terms of an opportunity to collect purchase intentions to increase the plurality of potential buyers participating in the purchase statement.

18. The method of claim 14, further comprising the step of calculating a logistical relative factor for use in the step of selecting a supplier based on a winning bid.

19. The method of claim 14, wherein the winning bid includes a maximum purchase available and further comprising the step of providing alternative offers for binding purchase orders after the supply offer has been activated.

20. A software application hosted on a computer system for access over the internet, comprising:
a joint purchase module for aggregating buyer purchase intentions from a plurality of potential buyers to generate a purchase statement defining an aggregate purchase opportunity for the plurality of potential buyers; and
a reverse auction module for conducting a reverse auction for a plurality of potential suppliers based on the purchase statement and generating a supply offer from a winning supplier that defines at least an offer price, an offer specification, and a minimum purchase requirement; and
wherein, the purchase statement does not legally bind the plurality of potential buyers to purchase;
the joint purchase module receives the supply offer and communicates a purchase conversion offer to the plurality of potential buyers with a period for response to the purchase conversion offer;
the joint purchase module receives conditional purchase orders from at least two of the plurality of potential buyers in response to the purchase conversion offer, aggregates the conditional purchase orders, compares them to the minimum purchase requirement, and activates the supply offer when the conditional purchase orders are equal to or greater than the minimum purchase requirement; and
the active supply offer converts the conditional purchase orders into binding purchase orders.
